(19) United States
(12) Patent Application Publication
(10) Pub. No.: US 2016/0017199 A1
(43) Pub. Date: Jan. 21, 2016

(54) SYSTEMS FOR EFFICIENT HEATING AND/OR COOLING AND HAVING LOW CLIMATE CHANGE IMPACT

(71) Applicant: HONEYWELL INTERNATIONAL INC., Morristown, NJ (US)

(72) Inventors: Samuel F. YANA MOTTA, East Amherst, NY (US); Robert G. RICHARD, Hamburg, NY (US); Mark W. SPATZ, East Amherst, NY (US); Rajiv Ratna SINGH, Getzville, NY (US)

(21) Appl. No.: 14/774,334

(22) PCT Filed: Mar. 12, 2014
(86) PCT No.: PCT/US14/24024

§ 371 Date: Sep. 10, 2015

Related U.S. Application Data
(60) Provisional application No. 61/799,598, filed on Mar. 15, 2013.

(51) Int. Cl. C09K 5/04

(52) U.S. Cl. CPC C09K 5/044; C09K 2205/40; C09K 2205/122

(57) ABSTRACT

The present invention relates, in part, to heat transfer systems, methods and compositions which utilize a heat transfer fluid comprising: (a) from about or greater than about 0% to about 15% by weight of HCFO-1233zd; (b) from about 65% to less than about 100% by weight of HFO-1234ze, or HFO-1234yf, or combinations thereof; and (c) from greater than about 0% to about 20% by weight of HFC-125, with the weight percent being based on the total of the components (a)-(c) in the composition.

### CROSS-REFERENCES TO RELATED APPLICATIONS

The present application claims priority to U.S. Provisional Application Ser. No. 61/799,598, filed Mar. 15, 2013, the contents of which are incorporated herein by reference in its entirety.

### FIELD OF THE INVENTION

The present invention relates, at least in part, to heat transfer compositions, and in particular to heat transfer and/or refrigerant compositions which may be suitable as replacements for the existing refrigerant HFC-134a.

### BACKGROUND

Mechanical refrigeration systems, and related heat transfer devices such as heat pumps and air conditioners, using refrigerant liquids are well known in the art for industrial, commercial and domestic uses. Fluorocarbon based fluids have found widespread use in many residential, commercial and industrial applications, including as the working fluid in systems such as air conditioning, heat pump and refrigeration systems, including commercial refrigeration, chillers, and relatively small systems such as are used for domestic refrigerators and freezers and in automobile air conditioning. Because of certain suspected environmental problems, including the relatively high global warming potentials, associated with the use of some of the compositions that have heretofore been used in these applications, it has become increasingly desirable to use fluids having low or even zero ozone depletion potential, such as hydrofluorocarbons (“HFCs”). For example, a number of governments have signed the Kyoto Protocol to protect the global environment and setting forth a reduction of CO2 emissions (global warming). Thus, there is a need for a low- or non-flammable, non-toxic alternative to replace certain of high global warming HFCs.

There has thus been an increasing need for new fluorocarbon and hydrofluorocarbon compounds and compositions that are attractive alternatives to the compositions heretofore used in these and other applications. For example, it has become desirable to retrofit chlorine-containing refrigeration systems by replacing chlorine-containing refrigerants with non-chlorine-containing refrigerant compounds that will not deplete the ozone layer, such as hydrofluorocarbons (HFC's). Industry in general and the heat transfer industry in particular are continually seeking new fluorocarbon based mixtures that offer alternatives to, and are considered environmentally safer substitutes for, CFCs and HCFCs. It is generally considered important, however, at least with respect to heat transfer fluids, that any potential substitute must also possess those properties present in many of the most widely used fluids, such as excellent heat transfer properties, chemical stability, low- or no-toxicity, non-flammability and/or lubricant compatibility, among others.

With regard to efficiency in use, it is important to note that a loss in refrigerant thermodynamic performance or energy efficiency may have secondary environmental impacts through increased fossil fuel usage arising from an increased demand for electrical energy.

Furthermore, it is generally considered desirably for CFC refrigerant substitutes to be effective without major engineering changes to conventional vapor compression technology currently used with CFC refrigerants.

Flammability is another important property for many applications. That is, it is considered either important or essential in many applications, including particularly in heat transfer applications, to use compositions which are non-flammable. Thus, it is frequently beneficial to use in such compositions compounds which are nonflammable. As used herein, the term “nonflammable” refers to compounds or compositions which are determined to be in Class 1 as determined in accordance with ASHRAE Standard 34-2007, including ANSI/ASHRI Addenda, which is incorporated herein by reference. Unfortunately, many HFC's which might otherwise be desirable for used in refrigerant compositions are not nonflammable and/or not Class 1. For example, the fluoroalkane difluoroethane (HFC-152a) and the fluoroalkene 1,1,1-trifluorpropene (HFO-1243zf) are each flammable and therefore not viable for use in many applications.

Applicants have thus come to appreciate a need for compositions, systems, and methods and particularly heat transfer compositions that are highly advantageous various heating and cooling systems and methods, particularly refrigerant and heat pump systems of the type that have herertofore been used with or designed for use with HFC-134a.

### SUMMARY

Applicants have found that the above-noted needs, and other needs, can be satisfied by compositions, methods and systems of the present invention. In certain aspects, the present invention relates to a heat transfer composition comprising: (a) from greater than about 0% to about 15% by weight of HFO-1233zd; (b) from about 65% to less than about 100% by weight of HFO-1234ze, or HFO-1234yf, or combinations thereof; and (c) from greater than about 0% to about 20% by weight of HFC-125, with the weight percent being based on the total of the components (a)-(c) in the composition.

In certain preferred aspects, the heat transfer composition includes (a) from greater than about 0% to about 10% by weight of HFO-1233zd; (b) from about 75% to less than about 100% by weight of HFO-1234ze, or HFO-1234yf, or combinations thereof; and (c) from greater than about 0% to about 15% by weight of HFC-125, with the weight percent being based on the total of the components (a)-(c) in the composition. In further preferred aspects, the heat transfer composition includes (a) from greater than about 0% to about 5% by weight of HFO-1233zd; (b) from about 85% to less than about 100% by weight of HFO-1234ze, or HFO-1234yf, or combinations thereof; and (c) from greater than about 0% to about 10% by weight of HFC-125, with the weight percent being based on the total of the components (a)-(c) in the composition. In even further preferred aspects, the heat transfer composition includes (a) from greater than about 0% to about 5% by weight of HFO-1233zd; (b) from about 90% to less than about 100% by weight of HFO-1234ze, or HFO-1234yf, or combinations thereof; and (c) from greater than about 0% to about 5% by weight of HFC-125, with the weight percent being based on the total of the components (a)-(c) in the composition. In even further preferred aspects, the heat transfer composition includes (a) from greater than about 0% to about 3.5% by weight of HFO-1233zd; (b) from about 92% to less than about 100% by weight of HFO-1234ze, or HFO-1234yf, or combinations thereof; and (c) from greater than about 0% to about 4.5% by weight of HFC-125, with the weight percent being based on the total of the components (a)-(c) in the composition.

In certain embodiments, said component (b) comprises, consists essentially of, or consists of HFO-1234ze, and in certain embodiments, it comprises, consists essentially of, or consists of trans-HFO-1234ze.

In further embodiments, component (b) comprises, consists essentially of, or consists of HFO-1234yf.

Applicants have also found that the above-noted needs, and other needs, can be satisfied by compositions, methods and systems of the present invention, wherein, in certain aspects, the heat transfer composition comprises: (a) from about 80% to less than about 100% by weight of HFO-1234ze, or HFO-1234yf, or combinations thereof; and (b) from greater than about 0% to about 20% by weight of HFC-125, with the weight percent being based on the total of the components (a)-(b) in the composition. In certain preferred aspects, the heat transfer composition includes (a) from about 85% to less than about 100% by weight of HFO-1234ze, or HFO-1234yf, or combinations thereof; and (b) from greater than about 0% to about 15% by weight of HFC-125, with the weight percent being based on the total of the components (a)-(b) in the composition. In further preferred aspects, the heat transfer composition includes (a) from about 90% to less than about 100% by weight of HFO-1234ze, or HFO-1234yf, or combinations thereof; and (b) from greater than about 0% to about 10% by weight of HFC-125, with the weight percent being based on the total of the components (a)-(b) in the composition. In even further preferred aspects, the heat transfer composition includes (a) from about 95% to less than about 100% by weight of HFO-1234ze, or HFO-1234yf, or combinations thereof; and (b) from greater than about 0% to about 5% by weight of HFC-125, with the weight percent being based on the total of the components (a)-(b) in the composition. In even further preferred aspects, the heat transfer composition includes (a) from about 95.5% to less than about 100% by weight of HFO-1234ze, or HFO-1234yf, or combinations thereof; and (b) from greater than about 0% to about 4.5% by weight of HFC-125, with the weight percent being based on the total of the components (a)-(b) in the composition.

In certain embodiments, said component (a) comprises, consists essentially of, or consists of HFO-1234ze, and in certain embodiments, it comprises, consists essentially of, or consists of trans-HFO-1234ze.

In further embodiments, component (a) comprises, consists essentially of, or consists of HFO-1234yf.

Applicants have unexpectedly found the combination of components in the present compositions, especially within the preferred ranges specified herein, are capable of at once achieving a combination of important and difficult to achieve refrigerant performance properties that cannot be achieved by any one of the components alone. For example, the preferred compositions of the present invention are at once Class 1 with respect to flammability and have a desirably low GWP. They also exhibit volumetric refrigeration capacity that is the same as, similar to, or within commercially tolerable deviation from HFC-134a (also referred to herein as “R-134a”), preferably as measured in accordance with American National Standard “Energy Performance and Capacity of Household Refrigerators, Refrigerator-Freezers and Freezers (ANSI/AHAM HRF-1-2007), which is incorporated herein by reference.

The present invention also relates to methods and systems which utilize the compositions of the present invention, including methods and systems for heat transfer and for retrofitting existing heat transfer systems. Certain preferred method aspects of the present invention relate to methods of providing cooling in existing refrigeration systems. Other method aspects of the present invention provide methods of retrofitting an existing systems designed to contain or containing R-134a refrigerant comprising introducing a composition of the present invention into the system without substantial engineering modification of said existing refrigeration system. In certain non-limiting aspects, the refrigeration system may include a unit selected from the group consisting of small refrigeration systems, low- and medium-temperature refrigeration systems, stationary air conditioners, automotive air conditioners, domestic refrigerator/freezers, chillers, heat pumps, vending machines, heat pump water heaters, and dehumidifiers.

The term “HFO-1234” is used herein to refer to all tetrafluoropropenes. Among the tetrafluoropropenes are included 1,1,1,2-tetrafluoropropene (HFO-1234yf) and both cis- and trans-1,1,1,3-tetrafluoropropene (HFO-1234ze). The term HFO-1234ze is used herein generically to refer to 1,1,1,3-tetrafluoropropene, independent of whether it is the cis- or trans-form. The terms “cisHFO-1234ze” and “transHFO-1234ze” are used herein to describe the cis- and trans-forms of 1,1,1,3-tetrafluoropropene respectively. The term “HFO-1234ze” therefore includes within its scope cisHFO-1234ze, transHFO-1234ze, and all combinations and mixtures of these.

The term HFCO-1233zd is used herein generically to refer to 1,1,1-trifluoro-3-chloropropene, independent of whether it is the cis- or trans-form. The terms “cisHFCO-1233zd” and “transHFCO-1233zd” are used herein to describe the cis- and trans-forms of 1,1,1-trifluoro-3-chloropropene, respectively. The term “HFCO-1233zd” therefore includes within its scope cisHFCO-1233zd, transHFCO-1233zd, and all combinations and mixtures of these.

The term “HFC-125” is used herein to refer to 1,1,1,2,2-pentafluoroethane.

### BRIEF DESCRIPTION OF THE FIGURES

FIG. 1 illustrates one embodiment of a chamber used for hot surface experiments

### DETAILED DESCRIPTION OF PREFERRED EMBODIMENTS

One refrigerant that has been commonly used in many heating and cooling systems, including small refrigeration systems (including small commercial refrigeration systems), low- and medium-temperature commercial refrigeration systems, stationary air conditioners, automotive air conditioners, domestic refrigerator/freezers, chillers, heat pumps, vending machines, screw water chillers, centrifugal water chillers, heat pump water heaters, dehumidifiers, and the like, is HFC-134a, which has an estimated high Global Warming Potential (GWP) of 1430. Applicants have found that the compositions of the present invention satisfy in an exceptional and unexpected way the need for alternatives and/or replacements for refrigerants in such applications, particularly and preferably HFC-134a. Preferred compositions at once have lower GWP values and provide non-flammable, non-toxic fluids that have a close match in volumetric capacity to HFC-134a in such systems.

In certain preferred forms, compositions of the present invention have a Global Warming Potential (GWP) of not greater than about 1000, more preferably not greater than about 700, and even more preferably about 600 or less. As used herein, “GWP” is measured relative to that of carbon dioxide and over a 100 year time horizon, as defined in “The Scientific Assessment of Ozone Depletion, 2002, a report of the World Meteorological Association's Global Ozone Research and Monitoring Project,” which is incorporated herein by reference.

In certain preferred forms, the present compositions also preferably have an Ozone Depletion Potential (ODP) of not greater than 0.05, more preferably not greater than 0.02 and even more preferably about zero. As used herein, “ODP” is as defined in “The Scientific Assessment of Ozone Depletion, 2002, A report of the World Meteorological Association's Global Ozone Research and Monitoring Project,” which is incorporated herein by reference.

Heat Transfer Compositions

The compositions of the present invention are generally adaptable for use in heat transfer applications, that is, as a heating and/or cooling medium, but are particularly well adapted for use, as mentioned above, in systems that have heretofor used HFC-134a.

In certain preferred embodiments, compositions of the present invention comprise, consist essentially of, or consist of: (a) 1,1,1,2,2-pentafluoroethane (HFC-125) and (b) 1,3,3,3-tetrafluoropropene (HFO-1234ze) and/or 2,3,3,3-tetrafluoropropene (HFO-1234yf). In other preferred embodiments, compositions of the present invention comprise, consist essentially of, or consist of: (a) 1-chloro-3,3,3-trifluoropropene (HCFO-1233zd), (b) 1,3,3,3-tetrafluoropropene (HFO-1234ze) and/or 2,3,3,3-tetrafluoropropene (HFO-1234yf); and (c) 1,1,1,2,2-pentafluoroethane (HFC-125).

Each of these components may be provided in any amount that renders it useful as a refrigerant composition, particularly as a replacement for HFC-134a in existing refrigerant systems, and even more particularly in small refrigeration systems, low- and medium-temperature refrigeration systems, stationary air conditioners, automotive air conditioners, domestic refrigerator/freezers, chillers, heat pumps, vending machines, screw water chillers, centrifugal water chillers, heat pump water heaters, dehumidifiers, and similar systems that use or can use HFC-134a as a refrigerant.

HCFO-1233zd may be provided as the cis isomer, the trans isomer, or a combination of the cis and trans isomers. In certain aspects, HCFO-1233zd comprises, consists essentially of, or consists of the trans isomer. In other embodiments, it comprises, consists essentially of, or consists of the cis isomer. HCFO-1233zd may be provided in an amount of from about or greater than about 0 wt. % to about or less than about 30% by weight of the compositions, in certain preferred aspects in an amount of about or greater than about 0 wt. % to about or less than about 15 wt. % by weight of the compositions, in further preferred aspects in an amount of about or greater than about 0 wt. % to about or less than about 10 wt. % by weight of the compositions, in even further preferred aspects in an amount of about or greater than about 0 wt. % to about or less than about 5 wt. % by weight of the compositions, and in even further preferred aspects in an amount of about or greater than about 0 wt. % to about or less than about 3.5 wt. % by weight of the compositions.

HFO-1234ze may be provided as the cis isomer, the trans isomer, or a combination of the cis and trans isomers. In certain aspects, it is provided in an amount of from about 50 wt. % to less than about 100 wt. % by weight of the compositions, in certain preferred aspects in an amount of from about 65 wt. % to less than about 100 wt. % by weight of the compositions, in further preferred aspects in an amount of from about 75 wt. % to less than about 100 wt. % by weight of the compositions, in even further preferred aspects in an amount of from about 85 wt. % to less than about 100 wt. %, by weight of the compositions, in even further preferred aspects in an amount of from about 90 wt. % to less than about 100 wt. % by weight of the compositions, and in even further preferred aspects in an amount of from about 92 wt. % to less than about 100 wt. % by weight of the compositions.

In further aspects, HFO-1234yf is provided in an amount of from about 50 wt. % to less than about 100 wt. % by weight of the compositions, in certain preferred aspects in an amount of from about 65 wt. % to less than about 100 wt. % by weight of the compositions, in further preferred aspects in an amount of from about 75 wt. % to less than about 100 wt. % by weight of the compositions, in even further preferred aspects in an amount of from about 85 wt. % to less than about 100 wt. % by weight of the compositions, in even further preferred aspects in an amount of from about 90 wt. % to less than about 100 wt. % by weight of the compositions, and in even further preferred aspects in an amount of from about 92 wt. % to less than about 100 wt. % by weight of the compositions.

In certain aspects, either HFO-1234ze or HFO-1234yf may be provided within the compositions of the present invention. In further aspects, they may be provided together. In such instances, the total amount of HFO-1234ze and HFO-1234yf may be in an amount of from about 65 wt. % to less than about 100 wt. % by weight of the compositions, in further preferred aspects in an amount of from about 75 wt. % to less than about 100 wt. % by weight of the compositions, in even further preferred aspects in an amount of from about 85 wt. % to less than about 100 wt. % by weight of the compositions, in even further preferred aspects in an amount of from about 90 wt. % to less than about 100 wt. % by weight of the compositions, and in even further preferred aspects in an amount of from about 92 wt. % to less than about 100 wt. % by weight of the compositions.

HFC-125 may be provided in an amount of from greater than 0 wt. % to less than about 30 wt. % by weight of the compositions, in certain preferred aspects in an amount of from greater than 0 wt. % to about or less than about 20 wt. % by weight of the compositions, in further preferred aspects in an amount of from greater than 0 wt. % to about or less than about 15 wt. % by weight of the compositions, in further preferred aspects in an amount of from greater than 0 wt. % to about or less than about 10 wt. % by weight of the compositions, in even further preferred embodiments from greater than 0 wt. % to about or less than about 5 wt. % by weight of the compositions, and in even further preferred embodiments from greater than 0 wt. % to about or less than about 4.5 wt. % by weight of the compositions.

Applicants have found that use of the components of the present invention within the broad and preferred ranges described herein is important to obtaining the difficult to achieve combinations of properties exhibited by the present compositions, particularly in the preferred systems and methods, and that use of these same components but substantially outside of the identified ranges can have a deleterious effect on one or more of the important properties of the compositions of the invention.

In highly preferred embodiments, highly preferred combinations of properties are achieved for compositions having a weight ratio of HCFO-1233zd:TPC (i.e. total amount of tetrafluoropropene provided) of from about 1:1 to about 1:50, with a ratio of from about 1:10 to about 1:35 being preferred in certain embodiments.

In highly preferred embodiments, highly preferred combinations of properties are achieved for compositions having a weight ratio of HFC-125:TPC (i.e. total amount of tetrafluoropropene provided) of from about 1:1 to about 1:50, with a ratio of from about 1:2 to about 1:30 being preferred in certain embodiments.

In highly preferred embodiments, highly preferred combinations of properties are achieved for compositions having a weight ratio of HCFO-1233zd:HFC-125 of from about 1:1 to about 1:20, with a ratio of from about 1:1 to about 1:10 being preferred in certain embodiments.

Although it is contemplated that either isomer of HFO-1234ze may be used, in certain aspects of the present invention, applicants have found transHFO-1234ze to be preferred. To this end, and in certain non-limiting embodiments, HFO-1234ze, comprises transHFO-1234ze in major proportion, and in certain embodiments consist essentially of transHFO-1234ze.

Although it is contemplated that either isomer of HCFO-1233zd may be used, in certain aspects of the present invention, applicants have found transHCFO-1233zd be to be preferred. To this end, and in certain non-limiting embodiments, HCFO-1233zd, comprises trans HCFO-1233zd in major proportion, and in certain embodiments consist essentially of trans HCFO-1233zd. In alternative embodiments, however, applicants have found cisHCFO-1233zd be to be preferred. To this end, and in certain non-limiting embodiments, HCFO-1233zd, comprises cis HCFO-1233zd in major proportion, and in certain embodiments consist essentially of cis HCFO-1233zd.

In certain preferred embodiments, the amounts of each of HCFO-1233zd, HFO-1234ze and/or HFO-1234yf, and HFC-125 are such that the resulting composition is substantially non-flammable, having a low GWP and performance (e.g. efficiency, capacity, glide, etc.) within commercially acceptable levels. As set forth in Example 6, below, HCFO-1233zd is effective as a flammability reducer. But to achieve non-flammability it must be provided to the composition at levels that decrease the performance. HFC-125 is similarly effective as a flammability reducer. But, to achieve non-flammability it also must be provided at levels in the composition to cause an undesirable increase in GWP. Applicants have surprisingly and unexpectedly found that by combining these two ingredients, less of each is required to obtain a non-flammable composition. To this end, non-flammability can be obtained with minimal impact to the performance and only a small increase in GWP.

By way of non-limiting example, the following Table A illustrates the substantial improvement the GWP of certain compositions of the present invention in comparison to the GWP of HFC-134a, which has a GWP of 1430.

TABLE A

| | | | GWP as a |
|---|---|---|---|
| Composition of the Invention (weight fraction, based on | | | Percentage of |
| identified components) | Name | GWP | R134a GWP |
| R134a | R134a | 1430 | 100% |
| R1234yf | A1 | 4 | 0.3% |
| R1234ze | A2 | 6 | 0.4% |
| R1234yf/R125 (0.96/0.04) | A3 | 144 | 10.1% |
| R1234yf/R125 (0.90/0.10) | A4 | 354 | 24.8% |
| R1234yf/R125(0.85/0.15) | A5 | 528 | 37.0% |
| R1234ze(E)/R125 (0.96/0.04) | A6 | 146 | 10.2% |
| R1234ze(E)/R125(0.90/0.10) | A7 | 355 | 24.8% |
| R1234ze(E)/R125(0.85/0.15) | A8 | 530 | 37.1% |
| R1234ze(E)/R125/R1233zd(E) (0.93/0.04/0.03) | A9 | 146 | 10.2% |
| R1234ze(E)/R125/R1233zd(E) (0.91/0.04/0.05) | A10 | 146 | 10.2% |
| R1234ze(E)/R125/R1233zd(E) (0.87/0.10/0.03) | A11 | 355 | 24.8% |
| R1234ze(E)/R125/R1233zd(E) (0.85/0.10/0.05) | A12 | 355 | 24.8% |
| R1234ze(E)/R125/R1233zd(E) (0.82/0.15/0.03) | A13 | 530 | 37.1% |
| R1234ze(E)/R125/R1233zd(E) (0.80/0.15/0.05) | A14 | 530 | 37.1% |
| R1234yf/R125/R1233zd(E) (0.93/0.04/0.03) | A15 | 144 | 10.1% |
| R1234yf/R125/R1233zd(E) (0.91/0.04/0.05) | A16 | 144 | 10.1% |
| R1234yf/R125/R1233zd(E) (0.87/0.10/0.03) | A17 | 354 | 24.8% |
| R1234yf/R125/R1233zd(E) (0.85/0.10/0.05) | A18 | 354 | 24.8% |
| R1234yf/R125/R1233zd(E) (0.82/0.15/0.03) | A19 | 528 | 37.0% |
| R1234yf/R125/R1233zd(E) (0.80/0.15/0.05) | A20 | 529 | 37.0% |

The compositions of the present invention may include other components for the purpose of enhancing or providing certain functionality to the composition, or in some cases to reduce the cost of the composition. For example, the present compositions may include co-refrigerants, lubricants, stabilizers, metal passivators, corrosion inhibitors, flammability suppressants, and other compounds and/or components, and the presence of all such compounds and components is within the broad scope of the invention.

In certain preferred embodiments, the refrigerant compositions according to the present invention, especially those used in vapor compression systems, include a lubricant, generally in amounts of from about 30 to about 50 percent by weight of the composition, and in some case potentially in amount greater than about 50 percent and other cases in amounts as low as about 5 percent. Furthermore, the present compositions may also include a compatibilizer, such as propane, for the purpose of aiding compatibility and/or solubility of the lubricant. Such compatibilizers, including propane, butanes and pentanes, are preferably present in amounts of from about 0.5 to about 5 percent by weight of the composition. Combinations of surfactants and solubilizing agents may also be added to the present compositions to aid oil solubility, as disclosed by U.S. Pat. No. 6,516,837, the disclosure of which is incorporated by reference. Commonly used refrigeration lubricants such as Polyol Esters (POEs) and Poly Alkylene Glycols (PAGs), polyalkylene glycol esters (PAG esters), PAG oils, silicone oil, mineral oil, polyalkyl benzenes (PABs), polyvinyl ethers (PVEs), poly(alpha-olefin) (PAO), and combinations thereof that are used in refrigeration machinery with hydrofluorocarbon (HFC) refrigerants may be used with the refrigerant compositions of the present invention. Commercially available mineral oils include Witco LP 250 (registered trademark) from Witco, Zerol 300 (registered trademark) from Shrieve Chemical, Sunisco 3GS from Witco, and Calumet R015 from Calumet. Commercially available alkyl benzene lubricants include Zerol 150 (registered trademark). Commercially available esters include neopentyl glycol dipelargonate, which is available as Emery 2917 (registered trademark) and Hatcol 2370 (registered trademark). Other useful esters include phosphate esters, dibasic acid esters, and fluoroesters. In some cases, hydrocarbon based oils are have sufficient solubility with the refrigerant that is comprised of an iodocarbon, the combination of the iodocarbon and the hydrocarbon oil might more stable than other types of lubricant. Such combination may therefore be advantageous. Preferred lubricants include polyalkylene glycols and esters. Polyalkylene glycols are highly preferred in certain embodiments because they are currently in use in particular applications such as mobile air-conditioning. Of course, different mixtures of different types of lubricants may be used.

Additional ingredients may include, but are not limited to, dispersing agents, cell stabilizers, cosmetics, polishing agents, medicaments, cleaners, fire retarding agents, colorants, chemical sterilants, stabilizers, polyols, polyol premix components and combinations thereof.

In certain preferred embodiments, the present compositions include, in addition to the compounds described above, one or more of the following as co-refrigerant:

Trichlorofluoromethane (CFC-11)

Dichlorodifluoromethane (CFC-12)

Difluoromethane (HFC-32)

Pentafluoroethane (HFC-125)

Difluoroethane (HFC-152a)

1,1,1,3,3,3-hexafluoropropane (HFC-236fa)

1,1,1,2,3,3-hexafluoropropane (HFC-236ea)

1,1,1,3,3-pentafluoropropane (HFC-245fa)

1,1,1,3,3-pentafluorobutane (HFC-365mfc)

1,1,1,2-tetrafluoroethane (HFC-134a)

water

CO₂

In certain aspects, such co-refrigerants may be provided in amounts of from greater than 0 to about 10 percent by weight of the composition, in further embodiments from greater than about 0 to about 5 percent by weight of the compositions, in further embodiments, from greater than about 0 to less than about 5 percent by weight of the composition, and in further embodiments from about 0.5 to less than about 5 percent by weight of the composition. In certain preferred embodiments the co-refrigerant may be selected from difluoroethane (HFC-152a); 1,1,1,2-tetrafluoroethane (HFC-134a); 1,1,1,2,3,3-hexafluoropropane (HFC-236ea); 1,1,1,3,3-pentafluoropropane (HFC-245fa); CO2; and combinations thereof. Such co-refrigerants may be provided in any amount, such as those above, but in certain embodiments is provided in an amount of greater than about 0 to about 5 percent by weight of the compositions, in further embodiments from greater than about 0 to less than about 5 percent by weight of the composition, and in further embodiments from about 0.5 to less than about 5 percent by weight of the composition. Such co-refrigerants and amount are not necessarily limiting to the invention and other co-refrigerants may be used in addition to or instead of any or more of the above-noted examples.

Heat Transfer Methods and Systems

The preferred heat transfer methods generally comprise providing a composition of the present invention and causing heat to be transferred to or from the composition, either by sensible heat transfer, phase change heat transfer, or a combination of these. For example, in certain preferred embodiments the present methods provide refrigeration systems comprising a refrigerant of the present invention and methods of producing heating or cooling by condensing and/or evaporating a composition of the present invention. In certain preferred embodiments, the systems and methods for heating and/or cooling, including cooling of other fluid either directly or indirectly or a body directly or indirectly comprise compressing a refrigerant composition of the present invention and thereafter evaporating said refrigerant composition in the vicinity of the article to be cooled.

In certain preferred aspects, the present methods, systems and compositions are thus adaptable for use in connection with a wide variety of heat transfer systems in general and refrigeration systems in particular, such as air-conditioning, refrigeration, heat-pump systems, dehumidifiers and chillers. In certain preferred embodiments, the compositions of the present invention are used in refrigeration systems originally designed for use with an HFC refrigerant, such as, for example, R-134a. The preferred compositions of the present invention tend to exhibit many of the desirable characteristics of R-134a but have a GWP that is substantially lower than that of R-134a while at the same time maintaining non-flammability and having a capacity that is substantially similar to or substantially matches, and preferably is as high as or higher than R-134a. In particular, applicants have recognized that certain preferred embodiments of the present compositions tend to exhibit relatively low global warming potentials (“GWPs”), preferably less than about 1,000, and more preferably not greater than about 700, and even more preferably not greater than about 600.

In certain other preferred embodiments, the present compositions are used in refrigeration systems originally designed for use with R-134a. Preferred refrigeration compositions of the present invention may be used in refrigeration systems containing a lubricant used conventionally with R-134a or may be used with other lubricants traditionally used with HFC refrigerants. As used herein the term “refrigeration system” refers generally to any system or apparatus, or any part or portion of such a system or apparatus, which employs a refrigerant to provide cooling. Such refrigeration systems include, for example, a small refrigeration system (including small commercial refrigeration systems), a medium-temperature commercial refrigeration system, a stationary air conditioner, automotive air conditioner, domestic refrigerator/freezer, chiller, heat pump, vending machine, screw water chiller, centrifugal water chiller, positive displacement compressor chillers, heat pump water heater, dehumidifiers, and the like.

The present invention achieves exceptional advantages in connection with commercial refrigeration systems (including low and medium temperatures systems) as well as in chillers. Non-limiting examples of such commercial refrigeration systems are provided in Example 1 (medium temperature applications), below. Performance in stationary refrigeration when suction-line/liquid-line heat exchanger is used is provided in Example 2, and an example of a chiller application is provided in Example 3, below. These examples below provide typical conditions and parameters that are used for such applications. These conditions, however, are not considered limiting to the invention, as one of skill in the art will appreciate that they may be varied based on one or more of a myriad of factors, including but not limited to, ambient conditions, intended application, time of year, and the like. Such examples are also not necessarily limiting to the definition of the term “commercial refrigeration system” or “chillers.” The compositions provided herein may be used in similar type systems or, in certain embodiments, in any alternative system where R-134a is or may be adapted for use as a refrigerant.

### EXAMPLES

The following examples are provided for the purpose of illustrating the present invention but without limiting the scope thereof.

### Example 1

### Performance in Stationary Refrigeration (Commercial Refrigeration)—Medium Temperature Applications

The performance of some preferred compositions were evaluated against other refrigerant compositions at conditions typical of medium temperature refrigeration. This application covers the refrigeration of fresh food. The conditions at which the compositions were evaluated are shown in Table 1:

TABLE 1

| | |
|---|---|
| Evaporating Temperature | 17.6° F. (−8° C.) |
| Condensing Temperature | 113° F. (45° C.) |
| Evaporator Superheat | 10° F. (5.5° C.) |
| Condenser Subcooling | 10° F. (5.5° C.) |
| Compressor Displacement | 1.0 ft³/min (0.028 m³/min) |
| Compressor Isentropic Eff. | 65% |
| Suction Line Superheat | 18° F. (10° C.) |

Table 2 compares compositions of interest to the baseline refrigerant, R-134a.

TABLE 2

| | | | Ev. | | | Press. | Suc. | Dis. | Dis. |
|---|---|---|---|---|---|---|---|---|---|
| | | | Glide | Cap. | COP | Ratio | Press. | Press. | Temp. |
| Components | Composition | GWP | (° C.) | (%) | (%) | (%) | (%) | (%) | (° C.) |
| R134a | 1.00 | 1430 | 0 | 100 | 100 | 100 | 100 | 100 | 85 |
| R1234yf | 1.00 | 4 | 0 | 95 | 95 | 90 | 110 | 99 | 70 |
| R1234ze | 1.00 | 6 | 0 | 74 | 100 | 103 | 74 | 76 | 75 |
| R1234yf/R125 | (0.96/0.04) | 144 | 0.3 | 97 | 94 | 90 | 113 | 102 | 71 |
| R1234yf/R125 | (0.90/0.10) | 354 | 0.6 | 100 | 94 | 90 | 118 | 106 | 71 |
| R1234yf/R125 | (0.85/0.15) | 528 | 0.9 | 103 | 94 | 90 | 122 | 110 | 72 |
| R1234ze(E)/R125 | (0.96/0.04) | 146 | 0.5 | 76 | 99 | 103 | 76 | 78 | 76 |
| R1234ze(E)/R125 | (0.90/0.10) | 355 | 1.2 | 80 | 99 | 103 | 81 | 83 | 76 |
| R1234ze(E)/R125 | (0.85/0.15) | 530 | 1.8 | 83 | 98 | 102 | 85 | 86 | 77 |
| R1234ze(E)/R125/R1233zd(E) | (0.93/0.04/0.03) | 146 | 2.4 | 72 | 100 | 105 | 71 | 75 | 78 |
| R1234ze(E)/R125/R1233zd(E) | (0.91/0.04/0.05) | 146 | 3.5 | 70 | 100 | 107 | 68 | 73 | 79 |
| R1234ze(E)/R125/R1233zd(E) | (0.87/0.10/0.03) | 355 | 3.3 | 76 | 99 | 105 | 75 | 79 | 78 |
| R1234ze(E)/R125/R1233zd(E) | (0.85/0.10/0.05) | 355 | 4.4 | 74 | 99 | 107 | 72 | 77 | 79 |
| R1234ze(E)/R125/R1233zd(E) | (0.82/0.15/0.03) | 530 | 4.0 | 79 | 99 | 105 | 79 | 83 | 79 |
| R1234ze(E)/R125/R1233zd(E) | (0.80/0.15/0.05) | 530 | 5.1 | 77 | 99 | 107 | 76 | 81 | 80 |
| R1234yf/R125/R1233zd(E) | (0.93/0.04/0.03) | 144 | 1.9 | 93 | 95 | 93 | 106 | 99 | 72 |
| R1234yf/R125/R1233zd(E) | (0.91/0.04/0.05) | 144 | 3.0 | 91 | 95 | 94 | 102 | 96 | 73 |
| R1234yf/R125/R1233zd(E) | (0.87/0.10/0.03) | 354 | 2.4 | 91 | 94 | 93 | 111 | 102 | 73 |
| R1234yf/R125/R1233zd(E) | (0.85/0.10/0.05) | 354 | 3.5 | 94 | 95 | 94 | 106 | 100 | 74 |
| R1234yf/R125/R1233zd(E) | (0.82/0.15/0.03) | 528 | 2.7 | 99 | 94 | 93 | 114 | 106 | 73 |
| R1234yf/R125/R1233zd(E) | (0.80/0.15/0.05) | 529 | 3.9 | 97 | 94 | 94 | 110 | 103 | 74 |

As can be seen from the Table 2 above, applicants have found that the compositions of the present invention are capable of at once achieving many of the important performance parameters sufficiently close to the parameters for R-134a to permit such compositions to be used as in new medium temperature refrigeration systems. For example, the compositions exhibit capacities in this refrigeration system that is within about 30%, and even more preferably within about 25% of that of R-134a. All these blends show efficiencies (COP) very similar to R134a which is very desirable. The compositions exhibit an evaporator glide less than about 1° C. and about 10° C. lower discharge temperatures both of which are very useful for medium temperature refrigeration applications. The compositions exhibit suction and discharge pressures which are about 20% lower than R134a which is also very desirable. Especially in view of the improved GWP, the compositions of the present invention offer a reduction of more than 50% making them excellent candidates for use in new equipment for medium temperature refrigeration applications.

Those skilled in the art will appreciate that the present compositions are capable of providing the substantial advantage of a refrigerant with low GWP and small glide for use in new or newly designed refrigeration systems, including preferably, medium temperature refrigeration systems.

### Example 2

### Performance in Stationary Refrigeration when Suction-Line/Liquid-Line Heat Exchanger is Used

The performance of some preferred compositions were evaluated against other refrigerant compositions at conditions typical of a refrigeration system by including a suction line heat exchanger. The conditions at which the compositions were evaluated are shown in Table 3:

TABLE 3

| Evaporating Temperature | −9.4° F. (−23° C.) |
|---|---|
| Condensing Temperature | 131° F. (55° C.) |
| Evaporator Superheat | 0° F. (0° C.) |
| Condenser Subcooling | 9° F. (5° C.) |
| Compressor Displacement | 1.0 ft³/min (0.028 m³/min) |
| Compressor Isentropic Eff. | 70% |
| Suction Line Superheat | 1.8° F. (1° C.) |
| SLHX Effectiveness | 0.9 |

Table 4 compares compositions of interest to the baseline refrigerant, R-134a.

TABLE 4

| | | | Ev. | | | Press. | Suc. | Dis. | Dis. |
|---|---|---|---|---|---|---|---|---|---|
| | | | Glide | Cap. | COP | Ratio | Press. | Press. | Temp. |
| Components | Composition | GWP | (° C.) | (%) | (%) | (%) | (%) | (%) | (° C.) |
| R134a | 1.00 | 1430 | 0 | 100 | 100 | 100 | 100 | 100 | 157 |
| R1234yf | 1.00 | 4 | 0 | 105 | 101 | 86 | 115 | 98 | 134 |
| R1234ze | 1.00 | 6 | 0 | 75 | 103 | 104 | 73 | 76 | 143 |
| R1234yf/R125 | (0.96/0.04) | 144 | 0.4 | 107 | 100 | 85 | 118 | 101 | 134 |
| R1234yf/R125 | (0.90/0.10) | 354 | 0.9 | 111 | 100 | 85 | 124 | 105 | 134 |
| R1234yf/R125 | (0.85/0.15) | 528 | 1.2 | 115 | 100 | 84 | 128 | 108 | 134 |
| R1234ze(E)/R125 | (0.96/0.04) | 146 | 0.7 | 78 | 103 | 103 | 76 | 78 | 143 |
| R1234ze(E)/R125 | (0.90/0.10) | 355 | 1.7 | 82 | 103 | 102 | 81 | 83 | 142 |
| R1234ze(E)/R125 | (0.85/0.15) | 530 | 2.4 | 86 | 102 | 101 | 86 | 86 | 142 |
| R1234ze(E)/R125/R1233zd(E) | (0.93/0.04/0.03) | 146 | 2.9 | 73 | 103 | 107 | 70 | 75 | 143 |
| R1234ze(E)/R125/R1233zd(E) | (0.91/0.04/0.05) | 146 | 4.1 | 71 | 103 | 109 | 67 | 73 | 143 |
| R1234ze(E)/R125/R1233zd(E) | (0.87/0.10/0.03) | 355 | 4.0 | 77 | 102 | 106 | 75 | 79 | 143 |
| R1234ze(E)/R125/R1233zd(E) | (0.85/0.10/0.05) | 355 | 5.2 | 75 | 102 | 108 | 72 | 77 | 143 |
| R1234ze(E)/R125/R1233zd(E) | (0.82/0.15/0.03) | 530 | 4.8 | 81 | 102 | 105 | 79 | 83 | 142 |
| R1234ze(E)/R125/R1233zd(E) | (0.80/0.15/0.05) | 530 | 6.1 | 78 | 102 | 107 | 76 | 81 | 142 |
| R1234yf/R125/R1233zd(E) | (0.93/0.04/0.03) | 144 | 2.3 | 102 | 100 | 88 | 110 | 97 | 135 |
| R1234yf/R125/R1233zd(E) | (0.91/0.04/0.05) | 144 | 3.6 | 98 | 100 | 90 | 105 | 95 | 135 |
| R1234yf/R125/R1233zd(E) | (0.87/0.10/0.03) | 354 | 2.9 | 106 | 100 | 88 | 115 | 101 | 135 |
| R1234yf/R125/R1233zd(E) | (0.85/0.10/0.05) | 354 | 4.3 | 102 | 100 | 90 | 110 | 99 | 135 |
| R1234yf/R125/R1233zd(E) | (0.82/0.15/0.03) | 528 | 3.4 | 109 | 99 | 87 | 120 | 105 | 135 |
| R1234yf/R125/R1233zd(E) | (0.80/0.15/0.05) | 529 | 4.8 | 105 | 99 | 90 | 114 | 102 | 135 |

### Example 3

### Performance in Positive Displacement Chillers

The performance of some preferred compositions were evaluated against other refrigerant compositions at conditions typical of chillers which can employ both positive-displacement or screw type compressors. The conditions at which the compositions were evaluated are shown in Table 5:

TABLE 5

| Evaporating Temperature | 41.9° F. (5.5° C.) |
|---|---|
| Condensing Temperature | 122° F. (50° C.) |
| Evaporator Superheat | 10° F. (5.5° C.) |
| Condenser Subcooling | 10° F. (5.5° C.) |
| Compressor Displacement | 1.0 ft³/min (0.028 m³/min) |
| Compressor Isentropic Eff. | 75% |

Table 6 compares compositions of interest to the baseline refrigerant, R-134a.

TABLE 6

| | | | Ev. | | | Press. | Suc. | Dis. | Dis. |
|---|---|---|---|---|---|---|---|---|---|
| | | | Glide | Cap. | COP | Ratio | Press. | Press. | Temp. |
| Components | Composition | GWP | (° C.) | (%) | (%) | (%) | (%) | (%) | (° C.) |
| R134a | 1.00 | 1430 | 0 | 100 | 100 | 100 | 100 | 100 | 68 |
| R1234yf | 1.00 | 4 | 0 | 93 | 96 | 93 | 107 | 99 | 58 |
| R1234ze | 1.00 | 6 | 0 | 75 | 100 | 102 | 74 | 76 | 61 |
| R1234yf/R125 | (0.96/0.04) | 144 | 0.3 | 95 | 95 | 93 | 109 | 101 | 59 |
| R1234yf/R125 | (0.90/0.10) | 354 | 0.7 | 99 | 95 | 93 | 114 | 105 | 59 |
| R1234yf/R125 | (0.85/0.15) | 528 | 1.0 | 101 | 95 | 93 | 118 | 109 | 60 |
| R1234ze(E)/R125 | (0.96/0.04) | 146 | 0.5 | 77 | 100 | 102 | 77 | 78 | 61 |
| R1234ze(E)/R125 | (0.90/0.10) | 355 | 1.3 | 81 | 99 | 102 | 81 | 83 | 62 |
| R1234ze(E)/R125 | (0.85/0.15) | 530 | 1.9 | 84 | 99 | 102 | 85 | 86 | 62 |
| R1234ze(E)/R125/R1233zd(E) | (0.93/0.04/0.03) | 146 | 2.4 | 74 | 100 | 104 | 72 | 75 | 63 |
| R1234ze(E)/R125/R1233zd(E) | (0.91/0.04/0.05) | 146 | 3.4 | 72 | 100 | 105 | 70 | 73 | 63 |
| R1234ze(E)/R125/R1233zd(E) | (0.87/0.10/0.03) | 355 | 3.3 | 78 | 100 | 104 | 76 | 79 | 63 |
| R1234ze(E)/R125/R1233zd(E) | (0.85/0.10/0.05) | 355 | 4.4 | 76 | 100 | 105 | 74 | 77 | 64 |
| R1234ze(E)/R125/R1233zd(E) | (0.82/0.15/0.03) | 530 | 4.0 | 81 | 99 | 104 | 80 | 83 | 64 |
| R1234ze(E)/R125/R1233zd(E) | (0.80/0.15/0.05) | 530 | 5.2 | 79 | 99 | 105 | 77 | 81 | 65 |
| R1234yf/R125/R1233zd(E) | (0.93/0.04/0.03) | 144 | 1.8 | 92 | 96 | 94 | 104 | 98 | 60 |
| R1234yf/R125/R1233zd(E) | (0.91/0.04/0.05) | 144 | 2.8 | 90 | 96 | 95 | 100 | 96 | 60 |
| R1234yf/R125/R1233zd(E) | (0.87/0.10/0.03) | 354 | 2.3 | 96 | 95 | 94 | 108 | 102 | 60 |
| R1234yf/R125/R1233zd(E) | (0.85/0.10/0.05) | 354 | 3.3 | 93 | 96 | 96 | 104 | 99 | 61 |
| R1234yf/R125/R1233zd(E) | (0.82/0.15/0.03) | 528 | 2.7 | 98 | 95 | 94 | 111 | 105 | 61 |
| R1234yf/R125/R1233zd(E) | (0.80/0.15/0.05) | 529 | 3.8 | 96 | 95 | 96 | 107 | 103 | 61 |

As can be seen from the Table 6 above, applicants have found that the compositions of the present invention are capable of at once achieving many of the important performance parameters sufficiently close to the parameters for R-134a to permit such compositions to be used as in chillers systems. For example, the compositions exhibit capacities in this refrigeration system that is within about 30%, and even more preferably within about 5% of that of R-134a in some cases. All these blends show efficiencies (COP) very similar to R134a which is very desirable. The compositions exhibit an evaporator glide less than about 5° C. and about 8° C. lower discharge temperatures both of which are very useful for these applications. Especially in view of the improved GWP, the compositions of the present invention offer a large reduction of more than 50% making them excellent candidates for use in new equipment for medium temperature refrigeration applications. In some cases (example: blends A3, A6, A9, A10, A15 and A16), GWP less than 150 are achieved while maintaining good performance and low hazard as shown in example 4 and 5.

### Example 4

### Hazard Evaluations

The Cube Test is performed pursuant to the procedure described herein. Specifically, each material being tested is separately released into a transparent cube chamber which has an internal volume of 1 ft³. A low power fan is used to mix components. An electrical spark with enough energy to ignite the test fluids is used. The results of all tests are recorded using a video camera. The cube is filled with the composition being tested so as to ensure a stoichiometric concentration for each refrigerant tested. The fan is used to mix the components. Effort is made to ignite the fluid using the spark generator for 1 min. Record the test using HD camcorder.

As also mentioned above, the compositions of the present invention should exhibit a degree of hazard value as low as possible. As used herein, degree of hazardousness is measured by observing the results of a cube test using the composition in question and applying a value to that test as indicated by the guidelines provided in the table below.

HAZARD VALUE GUIDELINE TABLE

| | HAZARD |
|---|---|
| TEST RESULT | VALUE RANGE |
| No ignition). Exemplary of this hazard level | 0 |
| are the pure materials R-134a and transHFO- | |
| 1234ze. | |
| Incomplete burning process and little or no | 1-2 |
| energy imparted to indicator balls and no | |
| substantial pressure rise in the cube (all balls | |
| rise an amount that is barely observable or not | |
| all from the cube holes and essentially no | |
| movement of the cube observed). Exemplary | |
| of this hazard level is the pure material HFO- | |
| 1234yf, with a value of 2. | |
| Substantially complete burning process and | 3-5 |
| low amount of energy imparted to some of the | |
| balls and substantially no pressure rise in the | |
| cube (some balls rise an observable small | |
| distance and return to the starting position, and | |
| essentially no movement of the cube | |
| observed).). Exemplary of this hazard level is | |
| the pure material R-32, with a value of 4. | |
| Substantially complete burning process and | 6-7 |
| substantial amount of energy imparted to most | |
| balls and high pressure rise in the cube but | |
| little or no movement of the cube (most balls | |
| rise an observable distance and do not return to | |
| the top of the cube, but little or no movement | |
| of the cube observed). | |
| High Hazard Conditions—Rapid burning and | 8-10 |
| substantial imparted to all balls and substantial | |
| energy imparted to the cube (substantially all | |
| balls rise from the cube and do not return to the | |
| starting position, and substantial movement of | |
| the cube observed).). Exemplary of this | |
| hazard level are the pure materials R-152a and | |
| R-600a, with values of 8 and 10 respectively. | |

The Hazardous rating of all the mixtures were calculated and are shown below in Table 7. All of the mixtures have a hazard rating of less than 7 and therefore would be expected to be safely used in air conditioning systems.

TABLE 7
Hazard Value of mixtures

| Name | Hazard |
|---|---|
| R32 | 4 |
| 1234ze | 0 |
| 1234yf | 2 |
| 1234yf/R125 (96/4) | 1 |
| 1234yf/1233zd (96/4) | 2 |
| 1234ze/R125 (96/4) | 0 |
| 1234ze/1233zd (96/4) | 0 |

Those skilled in the art will appreciate that the foregoing description and examples are intended to be illustrative of the invention but not necessarily limiting of the full and true broad scope of the invention, which will be represented by the appended claims as presented now or hereinafter.

### Example 5

### Hot Surface Evaluations

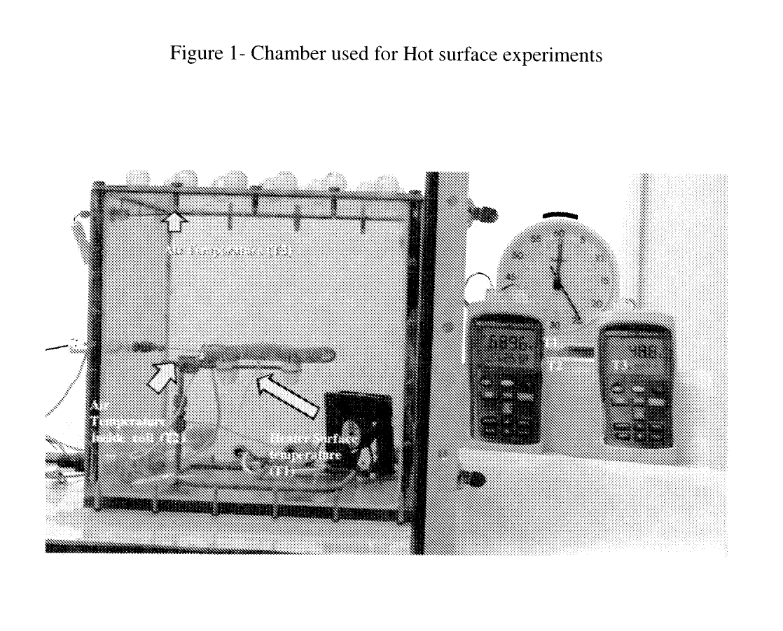

The Cube Test is performed pursuant to the procedure described herein. Specifically, each material being tested is separately released into a transparent cube chamber which has an internal volume of 1 ft³. A low power fan is used to mix components. An exposed-wire electric heater is energized (See FIG. 1) to produce high temperatures in the surface (up to 800 deg C). These types of heaters are used in air conditioning heat pumps as “auxiliary” of “supplementary” devices to make sure that the heating system fulfill the needs of the users in extremely cold days. Observations are done to see if ignition occurs and at what temperature this happens (See temperatures in FIG. 1). The results of all tests are recorded using a HD video camera. The cube is filled with the composition being tested so as to ensure a stoichiometric concentration for each refrigerant tested.

Initial experiments were performed with 1234yf and 1234ze to observe the surface temperature at which ignition occurs. The recorded temperatures for the two HFOs serve as baseline. Next we tested blends of each one of the HFOs (1234ze and 1234yf) with small amounts of the two main flammability suppressants (R125 and 1233zd). The effect adding these components, even in small quantities, unexpectedly increases the surface temperature at which ignition occurs. Overall the increase of the maximum permissible surface temperature would make the use of these heaters safer.

TABLE 8
Maximum Hot Surface Temperatures

| Refrigerant (compositions given by | Temperature | |
|---|---|---|
| weight where applicable) | (Deg C.) | |
| 1234yf | 654 | Baseline |
| 1234yf/R125 (96%/4%) | 721 | Increased by 67 deg C. |
| 1234yf/1233zd (97%/3%) | 720 | Increased by 66 deg C. |
| 1234ze | 696 | Baseline |
| 1234ze/R125 (96%/4%) | 722 | Increased by 26 deg C. |
| 1234ze/1233zd (97%/3%) | 721 | Increased by 25 deg C. |

Those skilled in the art will appreciate that the foregoing description and examples are intended to be illustrative of the invention but not necessarily limiting of the full and true broad scope of the invention, which will be represented by the appended claims as presented now or hereinafter.

### Example 6

### Fractionation of Blends

Blends of refrigerants experience change of composition (fractionation) when leaks occur in a vapor compression system. ASHRAE standard 34 clearly specifies procedures to calculate the nominal composition that would be considered non-flammable after experiencing fractionation. Table 9 discloses the Critical Fraction Ratio for the binary pairs of HFOs and the two flammability suppressants (1233zd and R125).

TABLE 9

| | Fraction of Flammability suppressant |
|---|---|
| Binary Pairs | (weight %) |
| 1234yf/R125 | 22.3% |
| 1234ze/R125 | 14.6% |
| 1234yf/1233zd | 64.3% |
| 1234ze/1233zd | 38.2% |

One can observe that the amount of flammability suppressant needed to make 1234yf non-flammable is larger than the one needed for 1234ze.

When looking at the ternary blends, we fixed the amount of 1233zd to 5% by weight so we do not affect performance of the blend. The intention of keeping 1233zd limited to 5% is to keep the capacity, efficiency and glide of the blend as close as possible of the reference (R134a). The question remains about the quantity of R125 needed to make any of the HFOs non-flammable when a fixed amount of 1233zd (5%) is used. Table 10 shows results obtained for the two blends in question.

First, the amount of 1233zd included is well below the CFR for the binary pairs (table 9 above shows 64.3% needed for 1234yf and 38.2% needed for 1234ze).

Second, the amounts of R125 needed are also below the CFR showed above. For the blend based of 1234yf, only 20.5% is needed which is below the 22.3% shown in table 9. In the case of the blend based on 1234ze, only 12.7% of R125 was needed while table 9 shows 14.6%.

These unexpected results allow the formulations of blends with slightly higher GWP but non-flammable according to ASHRAE.

TABLE 10

| | 1233zd | 1234yf | 1234ze | R125 |
|---|---|---|---|---|
| Blends | (weight %) | (weight %) | (weight %) | (weight %) |
| Blend based | 5% | 74.5% | — | 20.5% |
| on 1234yf | | | | |
| Blend based | 5% | — | 82.3% | 12.7% |
| on 1234ze | | | | |

What is claimed is:

1. A refrigerant composition having a low global warming potential and low hazard value comprising: (a) from greater than about 0% to about 15% by weight of HCFO-1233zd; (b) from about 65% to less than about 100% by weight of HFO-1234ze, or HFO-1234yf, or combinations thereof; and (c) from greater than about 0% to about 20% by weight of HFC-125, with the weight percent being based on the total of the components (a)-(c) in the composition and wherein the amount of said components (a)-(c) in said composition is effective to provide the heat transfer composition with a hazard value of not greater than 3.

2. The refrigerant composition of claim 1 comprising (a) from greater than about 0% to about 10% by weight of HCFO-1233zd; (b) from about 75% to less than about 100% by weight of HFO-1234ze, or HFO-1234yf, or combinations thereof; and (c) from greater than about 0% to about 15% by weight of HFC-125, with the weight percent being based on the total of the components (a)-(c) in the composition and wherein the amount of said components (a) and (c) together is not less than 3% by weight of the composition.

3. The refrigerant composition of claim 1 comprising (a) from greater than about 0% to about 5% by weight of HCFO-1233zd; (b) from about 90% to less than about 100% by weight of HFO-1234ze, or HFO-1234yf, or combinations thereof; and (c) from greater than about 0% to about 5% by weight of HFC-125, with the weight percent being based on the total of the components (a)-(c) in the composition and wherein the amount of said components (a) and (c) together is not less than 3% by weight of the composition.

4. The refrigerant composition of claim 1 comprising (a) from greater than about 0% to about 3.5% by weight of HCFO-1233zd; (b) from about 92% to less than about 100% by weight of HFO-1234ze, or HFO-1234yf, or combinations thereof; and (c) from greater than about 0% to about 4.5% by weight of HFC-125, with the weight percent being based on the total of the components (a)-(c) in the composition and wherein the amount of said components (a) and (c) together is not less than 3% by weight of the composition.

5. The refrigerant composition of claim 1 wherein said component (b) consists essentially of trans-HFO-1234ze, and/or HFO-1234yf.

6. A refrigerant composition having a low global warming potential and low hazard value comprising: (a) from about 80% to less than about 100% by weight of HFO-1234ze, or HFO-1234yf, or combinations thereof; and (b) from greater than about 0% to about 20% by weight of HFC-125, with the weight percent being based on the total of the components (a)-(b) in the composition and wherein the amount of said components (a)-(b) in said composition is effective to provide the heat transfer composition with a hazard value of not greater than 3.

7. The refrigerant composition of claim 6 comprising (a) from about 90% to less than about 100% by weight of HFO-1234ze, or HFO-1234yf, or combinations thereof; and (b) from greater than about 3% to about 10% by weight of HFC-125, with the weight percent being based on the total of the components (a)-(b) in the composition.

8. The refrigerant composition of claim 6 comprising (a) from about 95% to less than about 100% by weight of HFO-1234ze, or HFO-1234yf, or combinations thereof; and (b) from greater than about 3% to about 5% by weight of HFC-125, with the weight percent being based on the total of the components (a)-(b) in the composition.

9. The refrigerant composition of claim 6 wherein said component (a) consists essentially of trans-HFO-1234ze, and/or HFO-1234yf.

10. A refrigeration system comprising the refrigerant composition of any of the preceding claims.

11. A heat transfer system comprising a compressor, a condenser and an evaporator in fluid communication, and a refrigerant composition of any of claims 1-9 in said system.

12. A method of providing cooling in a commercial refrigeration system or a chiller that has a high level of safety and efficiency and low level of environmental impact, said method comprising:
(a) providing a commercial refrigeration system or a chiller system; and
(b) providing in said system a refrigerant composition comprising (a) from greater than about 0% to about 10% by weight of HCFO-1233zd; (b) from about 75% to less than about 100% by weight of HFO-1234ze, or HFO-1234yf, or combinations thereof; and (c) from greater than about 0% to about 15% by weight of HFC-125, with the weight percent being based on the total of the components (a)-(c) in the composition,
wherein: (i) the amount of said components (a) and (c) together is not less than 3% by weight of the composition: (ii) said refrigerant composition has a hazard value of not greater than 3; and (iii) said refrigerant composition has a global warming potential of not greater than 600.

13. The method of claim 11 wherein said refrigerant composition consists essentially of said components (a), (b) and (c).
